(19) United States
(12) Patent Application Publication
(10) Pub. No.: US 2003/0126105 A1
(43) Pub. Date: Jul. 3, 2003

(54) Computerized method and system for managing design report information

(76) Inventors: Dennis J. Kahler, Floyds Knobs, IN (US); William J. Harrity, Louisville, KY (US); Richard S. Rakowski, Prospect, KY (US); Glenn A. Just, Louisville, KY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/026,383

(22) Filed: Dec. 21, 2001

(51) Int. Cl. G06F 7/00

(52) U.S. Cl. 707/1

(57) ABSTRACT

Computerized method and system for managing report information usable by a plurality of users are provided. At least some of the users are responsible for advancing through one or more design stages at least one component design for a respective component of a machine. The method allows configuring a user-interface device to request initialization of a component design report for tracking a respective component design. The request includes information indicative of a site coordinator responsible for coordinating the requested component design among a plurality of users responsible for conducting the component design. The request further includes information indicative of component drawings and documentation applicable to the component design. The method further allows transmitting the request to a data center over a communications network, and providing a database configured to store the request transmitted to the data center. The database is further configured to store a plurality of business rules associated with the respective component design. A processing action allows to process the request relative to the business rules in the database to post each component design report to users responsible for performing tasks for advancing the component design through at least one of the design stages. An input/output device is configured to provide access to the database to each user responsible for performing a given task to retrieve at least one design item requiring disposition and approval prior to proceeding to a next design stage. The at least one design item is selected from the group consisting of component drawings and documentation applicable to the component design. The device is further configured to gather data indicative of component measurements and comments regarding disposition of the at least one design item. A code indicative of a level of approval, or lack thereof, is generated for the at least one design item in view of the gathered data so that in the event approval is granted, the component design can be advanced to the next design stage, and, in the event approval is denied, corrective actions are identified to remove any design deviations and obtain any required approval prior to advancing to the next design stage.

### BACKGROUND OF THE INVENTION

Known approaches to engineering design and development efforts tend to be costly and time consuming. Typically, design and development efforts begin with an initial idea or concept for a new product, for example, a dryer appliance using improved sensing techniques for accurately determining when a drying cycle should be completed based on the actual characteristics of the load.

From this initial idea, an initial design comprising drawings and written specifications is created. The drawings may be paper drawings or “blueprints” or may be three-dimensional drawings created using Computer Aided Design (CAD) software. The initial design will usually include certain specifications, such as component specifications (defining performance of a component), system specifications (defining performance of a system including the component), and interface design specifications (defining electronic or physical interfaces between a given component and other system components). In the case of a dryer, these documents may for example include a product specification detailing the performance criteria and “form, fit and function” of a moisture sensor; a system specification detailing the performance of the dryer including the moisture sensor and appropriate processing algorithms; and an interface design specification defining the electronic interface between the moisture sensor and a processor that processes the signal supplied by the sensor to determine termination of the dryer cycle based on the processing algorithms stored in the processor. These specifications may include various design criteria or performance parameters for the improved dryer, such as reliability requirements, mean time between failure, repeatability of cycle time estimation under similar load conditions, etc.

The initial idea or concept is translated into an initial design, e.g., Version 1 design. A plurality of teams, comprising one or more personnel, are formed to evaluate the design according to their various engineering, business and management specialties. Typically, there will be a management team whose primary function is to ensure that the development program is “on schedule” and “on cost.” There will be a business/accounting team who will analyze the costs of the development program and the expected costs of the product produced in quantity. There will be a series of engineering teams, each of a particular discipline or specialty. In our dryer example, there will be mechanical engineers, electrical engineers, software engineers, reliability engineers, safety engineers, signal processing specialists, production engineers, etc. Each of these teams will evaluate the initial design and associated specifications to determine conformance with requirements. In a typical development effort, these teams will recommend changes to the design to rectify deficiencies or improve performance. The design may evolve from the initial design to a version 2 design . . . and eventually to a final version design, as changes are recommended and implemented.

Because a number of different disciplines may be involved, it can be appreciated that the design process can be lengthy and costly. When one team implements design changes based on its analysis, other teams may have to reconsider their analysis as a result. For example, when a production engineer recommends (e.g., based on cost or manufacturability considerations) that one type of component will be employed instead of another type, the reliability engineer will need to reevaluate the design change. When an electrical engineer recommends that a new processor be used, the mechanical engineer will need to determine if packaging limits, are exceeded and the accountant will need to determine if design-to-cost parameters are exceeded.

Application of concurrent engineering techniques can improve the process somewhat by assembling the various specialists at the earliest possible time. Thus, manufacturing specialists are consulted from the beginning, rather than simply at the end. However, the dryer example illustrates how an engineering design effort, such as involving multiple disciplines, can be a lengthy and costly process as designs are considered and discarded, new designs are evaluated and so forth. When the various specialists are in different geographical locations, at different business entities or employ different information technology tools, the above-identified issues are compounded. The disparate locations, business cultures and format standards can be significant impediments. Further, having specialists of differing disciplines (with often conflicting priorities) attempt to resolve design issues when operating from different locations, or from business entities with differing business practices and cultures, or when using different communication tools can creates significant costs and obstacles in achieving a cost-effective design.

Once an acceptable design is arrived at, the developing business organization, such as the assignee of the present invention, would like to produce the design in quantity. In today's increasingly cost-conscious economy, where many business organizations have limited production facilities, may require “outsourcing” of many production aspects of a product. In some respects, the process of locating qualified, performance-proven suppliers can be as daunting as the engineering development effort. In the case of outsourcing to other countries, the engineering organization may not have established relationships with many—or any—manufacturers in such countries. Of the few potential candidates that may be identified through word-of-mouth or a time-consuming search, it can be very costly to accurately and reliably evaluate whether such candidates meet minimum requirements. Numerous trips and meetings may be required. Even then, it may be difficult to statistically ascertain the quality of past performance and the prospects for the proposed performance. The engineering concern may have to sustain unquantifiably-high cost and risk in divulging proprietary design and specification data. Because format standards may differ, the costs and risks of, sometimes imperfect, file conversions may be required.

Despite rigorous concurrent engineering, it is common that minor and not-so-minor redesigns may be required due to producibility and/or quality concerns. This would require additional engineering efforts to discuss and decide on engineering changes to arrive at a mutually acceptable and producible design that meets performance and cost requirements. Engineering issues aside, the negotiation process can be lengthy and costly. Documents, which may be proprietary, are sent to a bidding supplier. The bidding supplier must evaluate them, engage in discussions with the appropriate team about the design and specifications, and generate a bid. This bid typically includes terms relating to time, cost and performance. Upon receipt of the bid, additional discussions between the parties may be required to address engineering and/or contractual issues. Typically conducted using a combination of the phone, teleconference and postal service, these discussions impose additional costs and time in getting a product to market.

In view of the foregoing issues, it would be desirable to provide computer-based tool and techniques that would enable to quickly and at relatively low-cost conduct the various tasks or actions subsequent to or during any design development process in order to accurately and reliably verify that parts, components, materials, and any equipment, e.g., tooling equipment, involved or associated with any given design actually meet their intended function and/or comply with any applicable specifications. It would be further desirable to provide Internet-based system and techniques that allow providing electronic global routing, disposition and approval including signatures of information usable for achieving a cost-effective product design. It would be also desirable to develop historical archival and searching capability that would allow for sharing lessons learned in previous design endeavors.

### BRIEF SUMMARY OF THE INVENTION

Generally, one aspect of the present invention, fulfills the foregoing needs by providing a computerized method for managing report information usable by a plurality of users including users under independent business entities. At least some of the users are responsible for advancing through one or more design stages at least one component design for a respective component of a machine. The method allows configuring a user-interface device to request initialization of a component design report for tracking a respective component design. The request includes information indicative of a site coordinator responsible for coordinating the requested component design among a plurality of users responsible for conducting the component design. The request further includes information indicative of component drawings and documentation applicable to the component design. The method further allows transmitting the request to a data center over a communications network, and providing a database configured to store the request transmitted to the data center. The database is further configured to store a plurality of business rules associated with the respective component design. A processing action allows to process the request relative to the business rules in the database to post each component design report to users responsible for performing tasks for advancing the component design through at least one of the design stages. An input/output device is configured to provide access to the database to each user responsible for performing a given task to retrieve at least one design item requiring disposition and approval prior to proceeding to a next design stage. The at least one design item is selected from the group consisting of component drawings and documentation applicable to the component design. The device is further configured to gather data indicative of component measurements and comments regarding disposition of the at least one design item. A code indicative of a level of approval, or lack thereof, is generated for the at least one design item in view of the gathered data so that in the event approval is granted, the component design can be advanced to the next design stage, and, in the event approval is denied, corrective actions are identified to remove any design deviations and obtain any required approval prior to advancing to the next design stage.

The present invention further fulfils the foregoing needs by providing in another aspect thereof, a computerized system for managing report information usable by a plurality of users including users under independent business entities. At least some of the users are responsible for advancing through one or more design stages at least one component design for a respective component of a machine. The system includes a user-interface device configured to request initialization of a component design report for tracking a respective component design. The request includes information indicative of a site coordinator responsible for coordinating the requested component design among a plurality of users responsible for conducting said component design. The request further includes information indicative of component drawings and documentation applicable to the component design, the user-interface device further configured to transmit the request to a data center over a communications network. A database is configured to store the request transmitted to the data center. The database is further configured to store a plurality of business rules associated with the respective component design. A processor is configured to process the request relative to the business rules in the database to post each component design report to users responsible for performing tasks for advancing the component design through at least one of the design stages. An input/output device is configured to provide access to the database to each user responsible for performing a given task to retrieve at least one design item requiring disposition and approval prior to proceeding to a next design stage. The at least one design item is selected from the group consisting of component drawings and documentation applicable to the component design, the device is further configured to gather data indicative of component measurements and comments regarding disposition of said at least one design item. A code generator is configured to generate a code indicative of a level of approval, or lack thereof, for the at least one design item in view of the gathered data so that in the event approval is granted, the component design can be advanced to the next design stage, and, in the event approval is denied, corrective actions are identified to remove any design deviations and obtain any required approval prior to advancing to the next design stage.

### BRIEF DESCRIPTION OF THE DRAWINGS

The features and advantages of the present invention will become apparent from the following detailed description of the invention when read with the accompanying drawings in which:

FIG. 1 illustrates a schematic representation of a system that may be used for practicing a computerized method for managing and communicating report information usable by a plurality of users in accordance with aspects of the invention.

FIG. 2 illustrates a user interface configured to initialize or request a first piece report usable for performing a design evaluation and approval.

FIG. 3 illustrates a user interface configurable to select a site coordinator for a given design evaluation.

FIG. 4 illustrates a user interface configurable to flexibly and quickly search report data based on one or more search parameters.

FIG. 5 illustrates a user interface configurable to retrieve a worklist including report data applicable to the user retrieving the work list.

FIG. 6 illustrates a user interface configurable to quickly and accurately copy existing report data that may be applicable for conducting a new but related design evaluation.

FIGS. 7-9 illustrate respective user interfaces configurable to communicate data, e.g., textual, numerical and comment data, required to appropriately disposition a first piece report.

FIG. 10 illustrates a user interface configurable to communicate disposition data regarding a first piece report.

FIG. 11 illustrates a user interface configurable to append documentation data applicable to a given first piece report.

FIG. 12 illustrates a user interface configurable to retrieve historical data indicative of events that have occurred regarding a given first piece report.

### DETAILED DESCRIPTION OF THE INVENTION

Glossary

AME—Advanced Manufacturing Engineer

AQE—Advanced Quality Engineer

BCN—Business Change Notice

BCR—Business Change Request

CCB—Change Control Board

CIB—Change Implementation Board

CTQ—Critical to Quality

DE—Design Engineer

EMPIS—Engineering Materials and Process Information Service

FPR—First Piece Report

FQE—Field Quality Engineer

GD&T—Geometric Dimensioning and Tolerance

IAS—International Approval Services (Formerly AGA)

ISO—Organization for International Standards

LSL—Lower Specification Limit

MCS—Material Coordination Specialist

NPI—New Product Introduction

OCE—Office of the Chief Engineer

OSHA—Occupational Safety and Health Administration

PCE—Process Control Engineer

PIE—Process Improvement Engineer

PMQE—Purchased Material Quality Engineer

PMQS—Purchased Material Quality Specialist

PPM—Parts per Million

PPM—Purchasing Program Manager

SC#—Source Code #

SPC—Statistical Process Control

UL—Underwriter's Laboratory

USL—Upper Specification Limit

Overview

The present invention in one aspect thereof entails computer-based techniques beneficial to businesses, such as the assignee of the present invention, that may require timely and accurate collaborative efforts among a plurality of diverse users, often including external suppliers, in order to quickly and reliably develop from a conceptual stage to a production stage components for machines, such as consumer appliances, medical imaging equipment, aircraft engines, electromechancial equipment used for power generation and/or propulsion of vehicles such as locomotives. An evaluation tool colloquially referred to as “first piece” evaluation tool provides techniques for evaluating, documenting, dispositioning and submitting prototype samples, such as components, parts, sub-assemblies, major assemblies, and in some cases tooling. As used herein “first piece” process refers to the various tasks or actions subsequent to or during a development process that allow to accurately and reliably verify that parts, components, materials, and any equipment, e.g., tooling equipment, involved or associated with any given design actually meet their intended function and/or comply with any applicable specifications.

As will be appreciated by those skilled in the art, a successful first piece evaluation would be advantageous in any component qualification process since, for example, such an evaluation would provide information as to the ability of any applicable tooling or process to make a minimal number of parts (under specific or controlled conditions) that meet the applicable drawing and specifications. With an approved first piece evaluation, the component or process may then be utilized in an extended capability study to prove capability under other varying conditions.

In one exemplary embodiment, the first piece evaluation may be applied to:

all new components, assemblies, subassemblies, etc.

revisions to existing assemblies, subassemblies, etc.

changes in materials

situations occurring when the point of manufacture or subassembly changes (including a new supplier or sub-tier supplier)

any significant manufacturing, supplier or sub-tier supplier process changes

case-by-case situations as determined by appropriate users, e.g., AQE, Site Quality, or PMQE

situations involving new tooling or when existing tooling is modified or repaired

In addition to the first piece evaluation, the assignee's commitment to the highest standards of quality, such as exemplified by the “Six Sigma” quality level philosophy may entail additional evaluations to ensure conformance of tooling, equipment, and processes to the capability levels necessary to insure compliance on all parts and processes whenever CTQ (Critical-to-Quality) characteristics are specified. These additional measures could include prior-to-shipment recording, and review of CTQ related tool measurements and equipment or process parameter controls that directly or indirectly influence final part or assembly characteristics. The determination of which CTQ related tool dimensions or process parameters to be checked in this prior-to-shipment review may be based on a team consensus. (e.g., Design Engineering, AME, AQE, and Site Quality). It will be appreciated that although the present invention is described in the context of a first piece evaluation, the techniques of the present invention can be equally applicable to any such processes where decisions are made based on a team consensus involving multiple users across diverse boundaries and access to accurate and timely information to reach such decisions is of outmost importance.

### ILLUSTRATIVE SAMPLE REQUIREMENTS

The BCN generally shows the first piece component requirements and the initiating engineer would decide how many pieces are required for dimension, lab and appearance checks. The precise number of samples will obviously vary depending on the specific application. However, the discussion below should provide a generic guideline.

CTQ dimensions, at a minimum, should be checked on all feasibility parts, design confirmation parts, (prototype and production), and all long lead tooling and equipment items previously released. A deviation is generally required on “C” dispositions of long lead tools. Status will be reported at predefined reviews.

All part/component/material characteristics or specifications on the drawing should be measured or appraised from production tools (all cavities and multiple tools), equipment, etc., when initially submitted for first piece.

Each characteristic or specification measured/appraised should be evaluated to the Engineering Drawing requirements and a disposition code applied that clearly shows the first piece characteristic/specification. In addition, all CTQ characteristics or specifications measured should be clearly indicated on the first piece submittal by an upper case “CTQ” surrounded by brackets as in “(CTQ)”.

Exemplary first piece disposition codes may be as follows:

A—Acceptable.

B—Acceptable, drawing and/or specification to be changed to new tolerance indicated.

C—Not acceptable, however, parts may be used provided an appropriate deviation procedure is followed. Correct and resubmit new parts.

D—Not acceptable, correct and resubmit.

P—Provisional (should not be a CTQ characteristic), approval on existing tooling (Engineering would provide new tolerance acceptance limits for P disposition dimensions on First Piece Request form). Item must be corrected when retooled.

Thereafter on resubmittals, by way of example, the following characteristics should be (re)inspected and a new disposition assigned:

CTQ characteristics/specifications

revised drawing characteristics/specifications

Other than “A” or “B” dispositioned characteristics/specifications

dimensions involved in tooling modification or repair

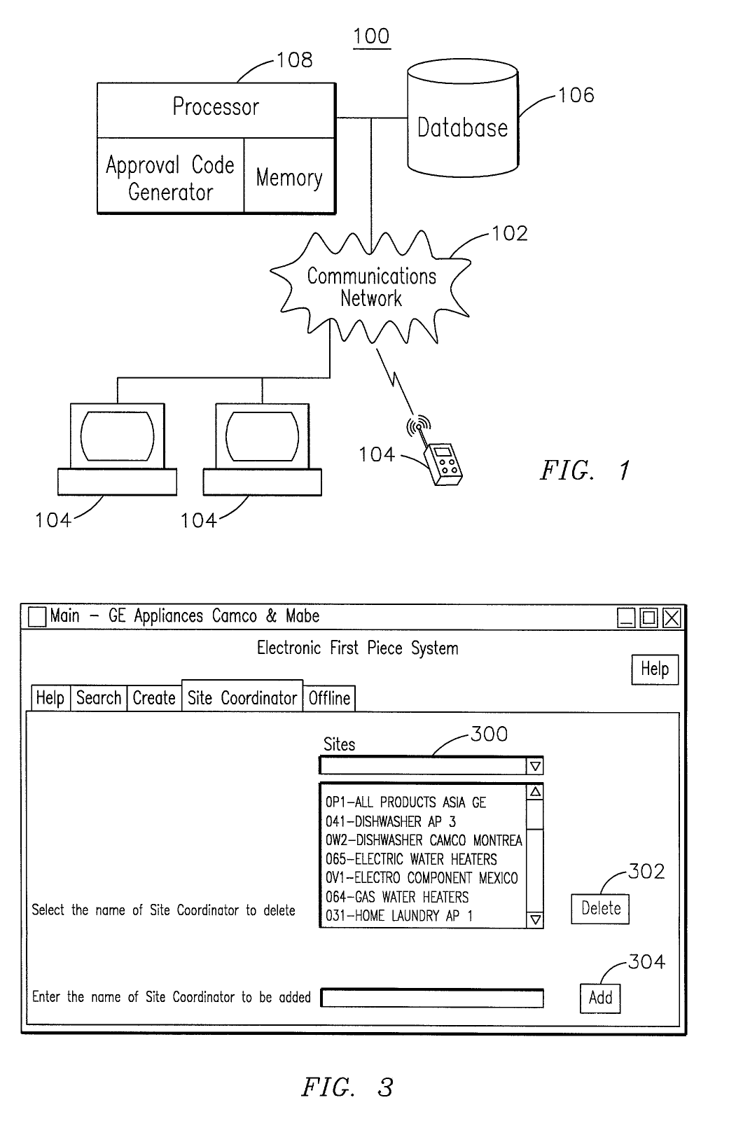

FIG. 1 illustrates an exemplary schematic representation of a system 100 that may be used for practicing a computerized method for managing and communicating report information usable by a plurality of users including users under independent business entities. As suggested above, some of the users are responsible for advancing through one or more design stages at least one component design for a respective component of a machine, or any other piece of equipment that may be assembled with other subsystems, systems, etc. System 100 includes devices that cooperate in a manner that, in one exemplary embodiment, allow for seamlessly integrating a plurality of users through a communications network 102, such as a local area network (LAN), wide area network (WAN), intranet, or the Internet. In one exemplary embodiment, remote terminals 104 using commercially available browsers, and Web-based applications are provided to each user. The remote terminal may comprise a personal computer, a laptop computer, a personal digital assistance (PDA) device, cellular telephone or any other wired or wireless device that enables communication of computer-readable data.

In one exemplary embodiment, a user-interface device, such as any of remote terminals 104, may be configured as a Web page, to request initialization of a component design report for tracking a respective component design. The request includes information indicative of a site coordinator responsible for coordinating the requested component design among a plurality of users responsible for conducting the component design. The request further includes information indicative of component drawings and documentation applicable to the component design. The user-interface device is further configured to transmit the request to a data center over the communications network. System 100 further includes a database 106 configured to store any requests transmitted to the data center. The database is further configured to store a plurality of business rules associated with the respective component design. A processor 108 is configured to process the request relative to the business rules in the database to post each component design report to users responsible for performing tasks for advancing the component design through at least one of the design stages. It will be appreciated that the business rules could be stored in a suitable memory 112 part of processor 108 in lieu of database 106.

Each remote terminal 104 may also be operable as an input/output device configured to provide access to database 106 to each user responsible for performing a given task to retrieve at least one design item requiring disposition and approval prior to proceeding to a next design stage. In one exemplary embodiment, the design item may include component drawings and documentation applicable to the component design. The device is further configured to gather data indicative of component measurements and comments regarding disposition of the design item. A code generator 110 is configured to generate a code indicative of a level of approval, or lack thereof, for any design item in view of the gathered data so that in the event approval is granted, the component design can be advanced to the next design stage, and, in the event approval is denied, corrective actions are identified to remove any design deviations and obtain any required approval prior to advancing to the next design stage. Although the description below makes reference to Web-based applications, it will be apparent that such a reference is to be construed as illustrative and should not be construed as a limitation of the present invention.

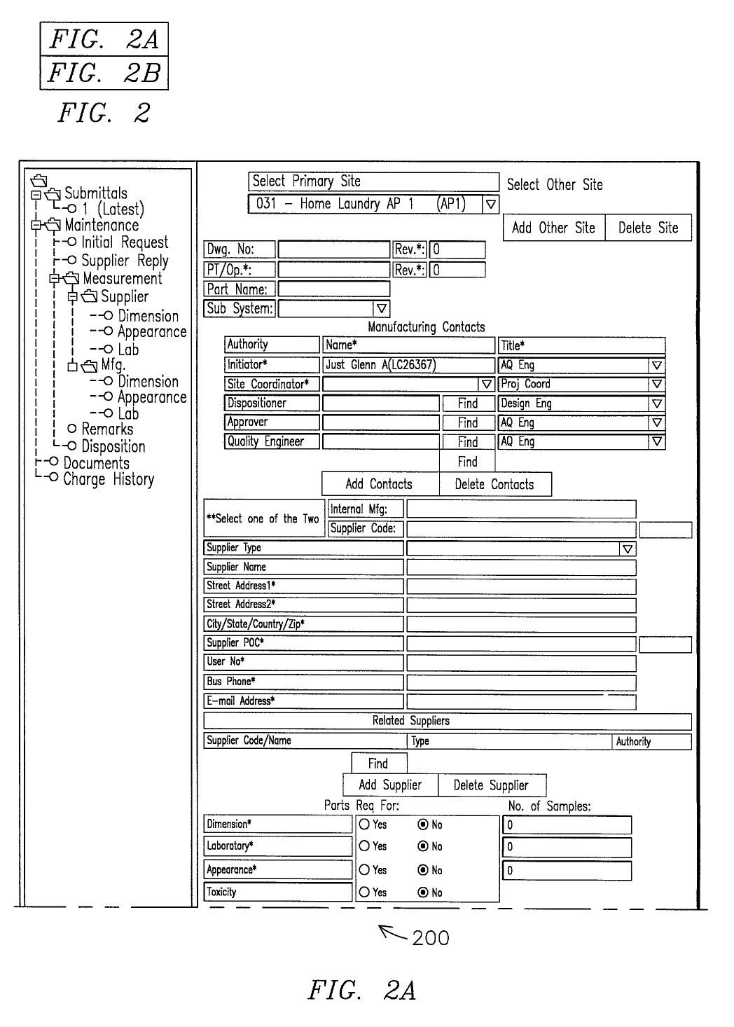

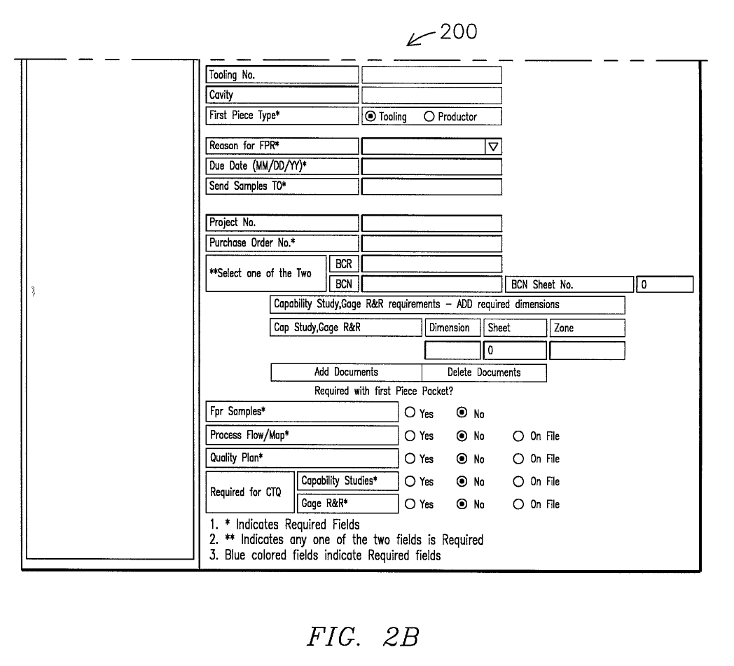

FIG. 2 illustrates a user interface 200 configured to initialize a first piece report. Appendix 1 provides an exemplary piece report labeled with numbered circles or bubbles to facilitate description of the various exemplary data fields included in such report. Appendix 2 describes exemplary responsibilities and procedures commonly encountered in a typical first piece evaluation. Appendix 3 includes definitions of some terms commonly used in the context of a first piece evaluation.

As illustrated in greater detail in FIG. 3, a drop down menu 300 is provided for selecting a site responsible for conducting a first piece evaluation. In addition, respective clickable icons 302 and 304 are provided for adding or deleting a site coordinator, provided the user has the appropriate administrative authority for adding or deleting site coordinators. Table 1 below illustrates exemplary user roles for performing a first piece evaluation.

Description of Exemplary User Roles:

TABLE 1

| | No/ | |
|---|---|---|
| Mfg User Role | FPR | Description of Role |
| Initiator | 1 | individual who initiates/creates the |
| | | original request |
| Site | >=1 | Individual who owns this process at the site |
| Coordinator | | and is responsible for ensuring a dispositioner |
| | | and approver has been assigned to a request |
| | | and for forwarding on requests to the |
| | | dispositioner after confirming receipt |
| | | of requirements back from supplier. |
| Dispositioner | 1 | Individual responsible for |
| | | reviewing and dispositioning the |
| | | measurements entered by the supplier |
| | | and moving request on to approver. |
| Approver | >=1 | Individual responsible for assigning the overall |
| | | dipsosition on the request and rejecting request to |
| | | submit back to supplier or accepting the request |
| | | (as shown by the status flow chart). |
| Quality | >=1 | Possible titles are “PMQE” or “AQE”. Which is |
| | | appropriate to be determined by if the part is |
| | | purchased (PMQE) or internally manufactured |
| | | (AQE). |
| CC | >=0 | Member of contact list. |
| Contact List | | Anyone listed in the contact list for a first piece |
| | | request (assigned one of the roles above or CC). |

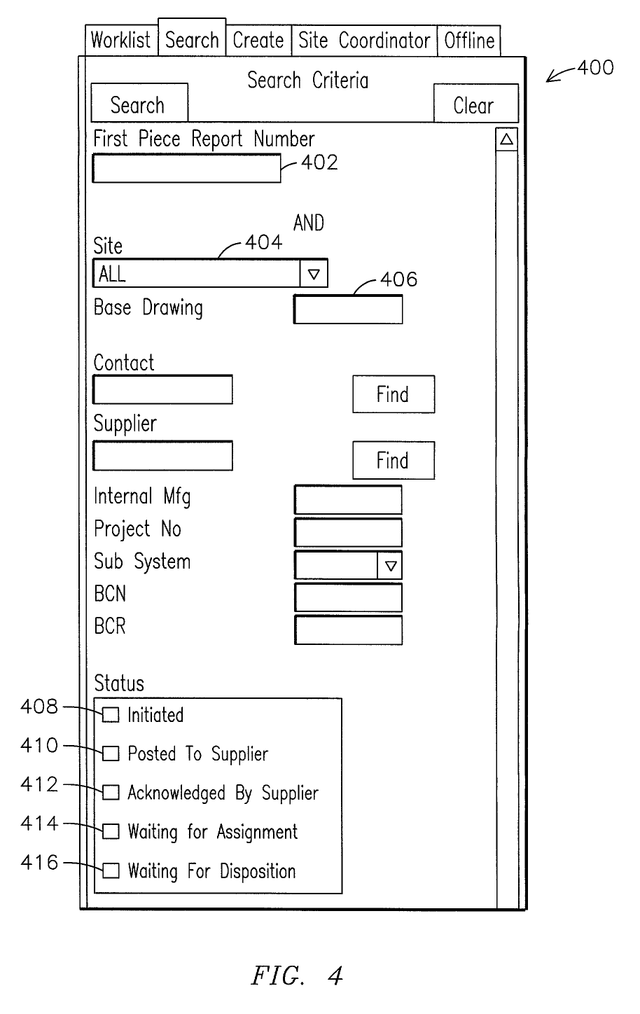

FIG. 4 illustrates a user interface 400 including data fields configurable for conducting a report search based on one or more search parameters, such as report initiator, site coordinator, component name, drawing number, report number, project number, present status of report, supplier of the component, any user identified as a point of contact for any given report, site responsible for the component design, etc. For example, data field 402 allows for searching based on the number of the first piece report. Data field 404 allows for searching based on the site responsible for coordinating the first piece evaluation. Data field 406 allows for searching based on drawing number. Clickable fields 408, 410 . . . and 416 may be respectively selected to search each report in database 106 based on their respective status, such as whether the report has been initiated, posted to a supplier, acknowledged by the supplier, waiting for assignment or is awaiting disposition. Typically, an e-mail or other equivalent communication will be sent to a user to inform that user that he/she needs to perform an action in connection with a given first piece report.

FIG. 5 illustrates a user interface 500 including a clickable icon 502 for accessing a working list including each component design report and associated tasks that require action from a respective user. For example, the working list of Jane Doe indicates that there are five reports listed as initiated, one report listed as posted to a supplier, and one report listed as acknowledged by the supplier. Further, Jane Doe may select submitted reports from a window 504 that displays submitted reports.

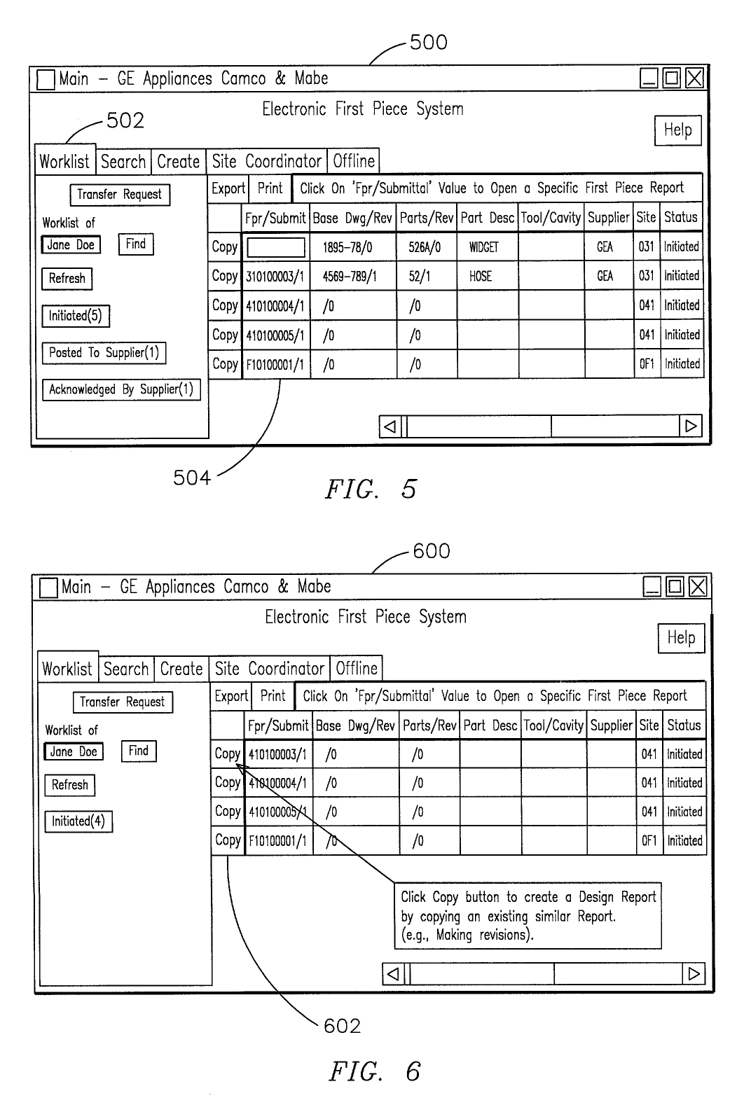

FIG. 6 illustrates a user interface 600 including clickable icons 602 for electronically copying files from an existing report including component drawings and documentation usable for a new component design report. For example, a user by clicking the copy icon next to each respective existing first piece report may copy each such existing report for appropriate use regarding a new report related to the existing report. This feature is particularly helpful for making use of already developed and available report information that could be used in a new but related design evaluation.

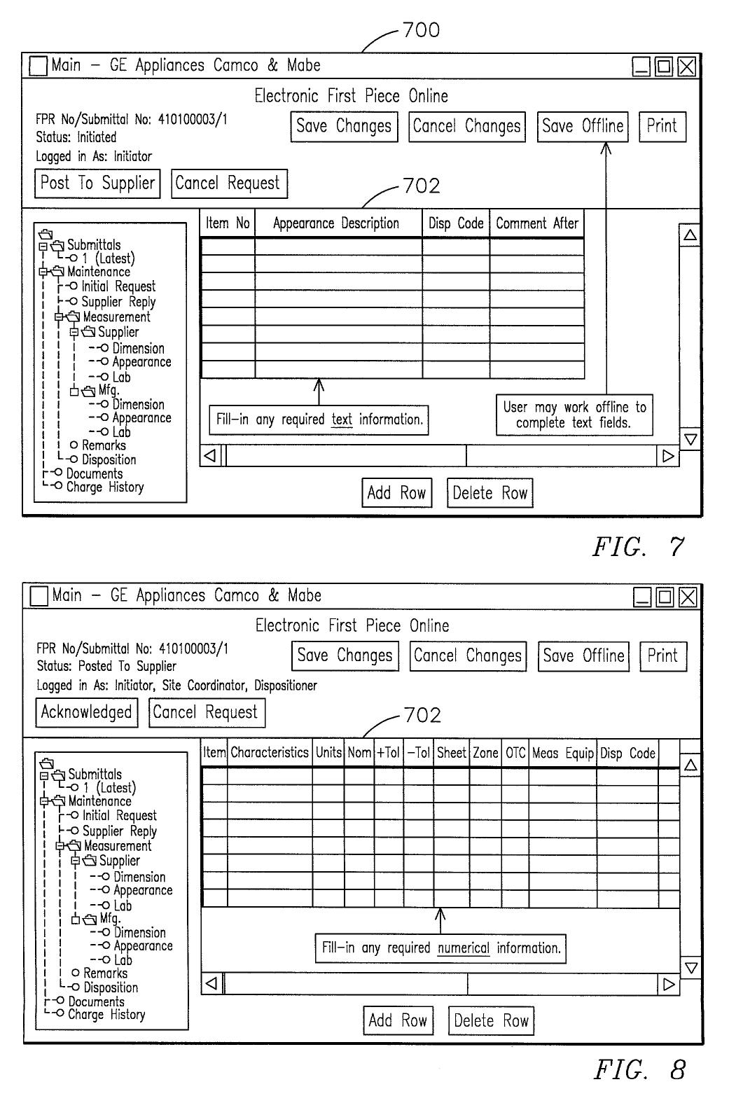

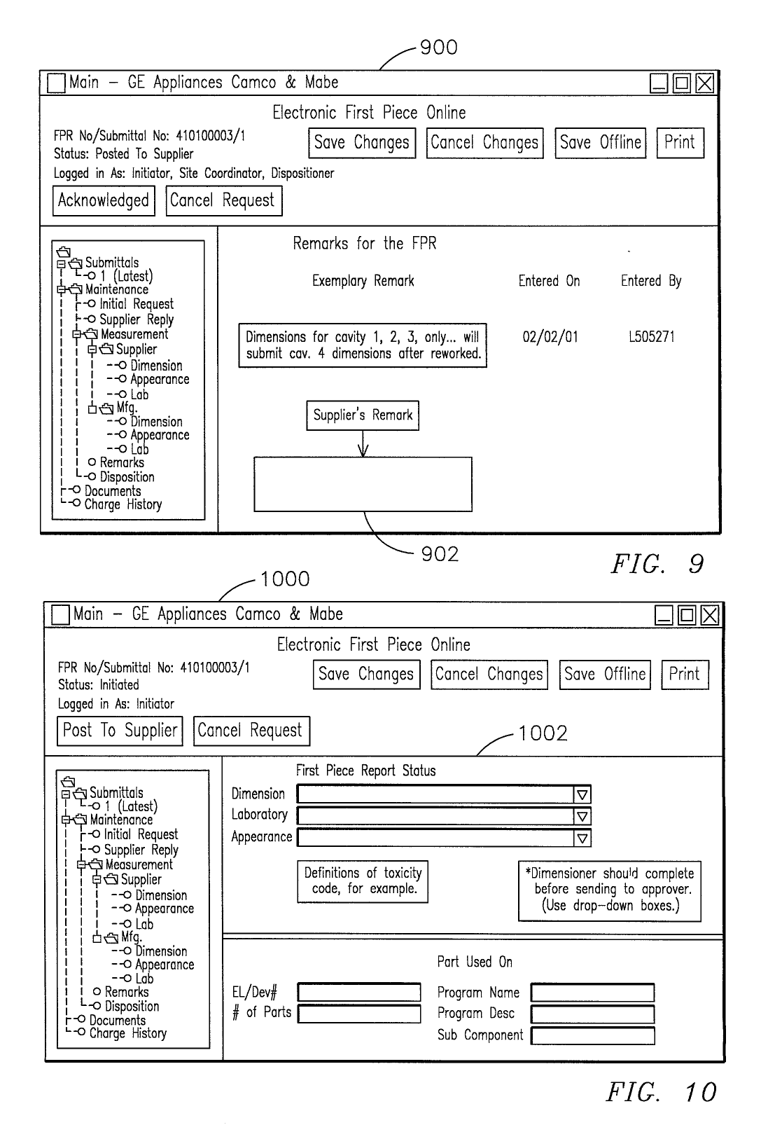

FIG. 7 illustrates a user interface 700 including a window 702 that may be used for entering textual data regarding the appearance of a given component being evaluated with the first piece tool. Similarly, FIG. 8 illustrates a user interface 800 including a window 802 that may be used for entering numerical data regarding the dimensions of a given component being evaluated with the first piece tool. FIG. 9 illustrates a user interface 900 that may be configured to enter comment or remarks data regarding a component being evaluated with the first piece tool. It will be appreciated that providing and/or accessing report information as illustrated in FIGS. 7-9 is particularly helpful to avoid loss of time due to illegible entries, or lost or misplaced reports, such as commonly occurs in paper-based techniques.

FIG. 10 illustrates a user interface 1000 including respective data fields 1002 that may be used for communicating data regarding the disposition and approval of a given report prior to proceeding to a next design stage of a given component being evaluated with the first piece tool based on the various data gathered using the techniques illustrated in the context of FIGS. 7-9.

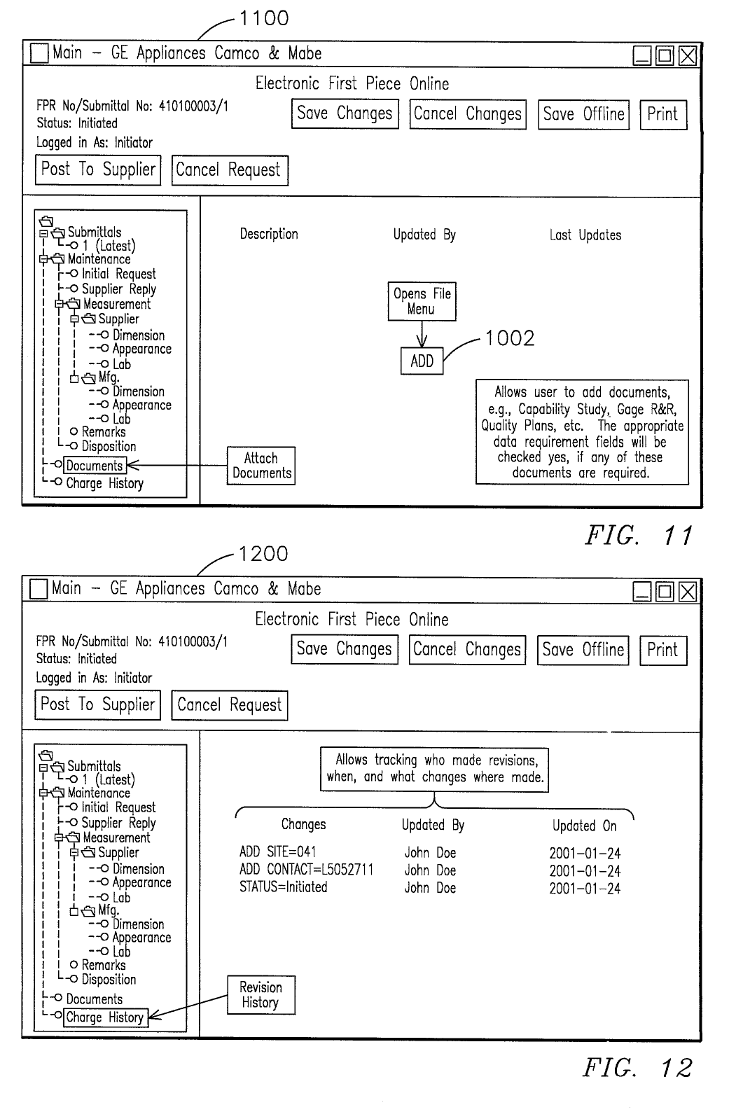

FIG. 11 illustrates a user interface 1100 that allows to add documentation relevant to a component undergoing evaluation with the first piece tool. Examples of documentation that may now be conveniently linked to each report include capability studies, Gage R&R, Quality Plans, etc. This feature allows users to advantageously focus on the tasks at hand, as opposed to having to spend valuable time in locating often voluminous and cumbersome documentation. As suggested above, database 106 may be populated with approved first piece reports and then become a valuable archival tool that would allow new users to learn the key issues that designers encountered in previous designs. This would allow the users to be more efficient since they would be able to learn from the lessons of previous designs, without having to experience the costs and delays that may have been encountered by previous designers.

FIG. 12 illustrates a user interface 1200 configured to track information regarding any first piece report. This information allows to readily answer questions such as who, when, why and what revisions have been made regarding the design of any component undergoing first piece evaluation.

### Some Exemplary Benefits of the E-First Piece Tool

Users receive instant email notification of requirements and requests.

Eliminate the need for excess paper reporting.

Provides faster dissemination of information.

Automatic disposition of all “A” characteristics.

Prevent deciphering of handwritten information, all information is typed and legible.

Saves time by allowing users to copy and attach information that may be similar for several e-First Piece documents.

Gives users searching and archival capabilities of report data.

The present invention can be embodied in the form of computer-implemented processes and apparatus for practicing those processes. The present invention can also be embodied in the form of computer program code including computer-readable instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. When implemented on a computer, the computer program code segments configure the computer to create specific logic circuits or processing modules.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A computerized method for managing report information usable by a plurality of users including users under independent business entities, at least some of the users responsible for advancing through one or more design stages at least one component design for a respective component of a machine, the method comprising:
configuring a user-interface device to request initialization of a component design report for tracking a respective component design, said request including information indicative of a site coordinator responsible for coordinating the requested component design among a plurality of users responsible for conducting said component design, said request further including information indicative of component drawings and documentation applicable to the component design;
transmitting the request to a data center over a communications network;
providing a database configured to store the request transmitted to the data center, the database further configured to store a plurality of business rules associated with the respective component design;
processing the request relative to the business rules in the database to post each component design report to users responsible for performing tasks for advancing the component design through at least one of the design stages;
providing an input/output device configured to provide access to said database to each user responsible for performing a given task to retrieve at least one design item requiring disposition and approval prior to proceeding to a next design stage, said at least one design item selected from the group consisting of component drawings and documentation applicable to the component design, said device further configured to gather data indicative of component measurements and comments regarding disposition of said at least one design item; and
generating a code indicative of a level of approval, or lack thereof, for said at least one design item in view of the gathered data so that in the event approval is granted, the component design can be advanced to the next design stage, and, in the event approval is denied, corrective actions are identified to remove any design deviations and obtain any required approval prior to advancing to the next design stage.

2. The computerized method of claim 1 further comprising populating the database with previously performed component design reports for each respective component of the machine.

3. The computerized method of claim 1 wherein the user-interface device includes a data field configurable for conducting a report search based on one or more search parameters, with at least one of said search parameters selected from the group consisting of report initiator, site coordinator, component name, drawing number, report number, machine type, present status of report, supplier of the component, any user identified as a point of contact for any given report, and site responsible for the component design.

4. The computerized method of claim 1 wherein the user-interface device includes a clickable icon for electronically copying files from an existing report including component drawings and documentation usable for a new component design report.

5. The computerized method of claim 1 wherein the user-interface device includes a clickable icon for accessing a working list including each component design report and associated tasks that require action from a respective user.

6. The computerized method of claim 1 wherein the user-interface device includes a clickable icon for accessing a list indicative of the status of each respective component design report and tasks associated therewith.

7. A computerized system for managing report information usable by a plurality of users including users under independent business entities, at least some of the users responsible for advancing through one or more design stages at least one component design for a respective component of a machine, the system comprising:
a user-interface device configured to request initialization of a component design report for tracking a respective component design, said request including information indicative of a site coordinator responsible for coordinating the requested component design among a plurality of users responsible for conducting said component design, said request further including information indicative of component drawings and documentation applicable to the component design, the user-interface device further configured to transmit the request to a data center over a communications network;
a database configured to store the request transmitted to the data center, the database further configured to store a plurality of business rules associated with the respective component design;
a processor configured to process the request relative to the business rules in the database to post each component design report to users responsible for performing tasks for advancing the component design through at least one of the design stages; and
an input/output device configured to provide access to said database to each user responsible for performing a given task to retrieve at least one design item requiring disposition and approval prior to proceeding to a next design stage, said at least one design item selected from the group consisting of component drawings and documentation applicable to the component design, said device further configured to gather data indicative of component measurements and comments regarding disposition of said at least one design item; and
a code generator configured to generate a code indicative of a level of approval, or lack thereof, for said at least one design item in view of the gathered data so that in the event approval is granted, the component design can be advanced to the next design stage, and, in the event approval is denied, corrective actions are identified to remove any design deviations and obtain any required approval prior to advancing to the next design stage.

8. The computerized system of claim 7 wherein the database is populated with previously performed component design reports for each respective component of the machine.

9. The computerized system of claim 7 wherein the user-interface device includes a data field configurable for conducting a report search based on one or more search parameters, with at least one of said search parameters selected from the group consisting of report initiator, site coordinator, component name, drawing number, report number, machine type, present status of report, supplier of the component, any user identified as a point of contact for any given report, and site responsible for the component design.

10. The computerized system of claim 7 wherein the user-interface device includes a clickable icon for electronically copying files from an existing report including component drawings and documentation usable for a new component design report.

11. The computerized system of claim 7 wherein the user-interface device includes a clickable icon for accessing a working list including each component design report and associated tasks that require action from a respective user.

12. The computerized system of claim 7 wherein the user-interface device includes a clickable icon for accessing a list indicative of the status of each respective component design report and tasks associated therewith.

13. A computer-readable medium including instructions for causing a computer to manage report information usable by a plurality of users by:
configuring a user-interface device to request initialization of a component design report for tracking a respective component design through a plurality of design stages, said request including information indicative of component drawings and documentation applicable to the component design;
transmitting the request to a data center over a communications network;
configuring a database to store the request transmitted to the data center, the database further configured to store a plurality of business rules associated with the respective component design;
processing the request relative to the business rules in the database to post each component design report to users responsible for performing tasks for advancing the component design through at least one of the design stages;
configuring an input/output device to provide access to said database to each user responsible for performing a given task to retrieve at least one design-related item requiring disposition and approval prior to proceeding to a next design stage, said at least one item selected from the group consisting of component drawings and documentation applicable to the component design, said device further configured to gather data indicative of component measurements and comments regarding disposition of said at least one design item; and
generating a code indicative of a level of approval, or lack thereof, for said at least one design item in view of the gathered data so that in the event approval is granted, the component design can be advanced to the next design stage, and, in the event approval is denied, corrective actions are identified to remove any design deviations and obtain any required approval prior to advancing to the next design stage.

14. The computer-readable medium of claim 13 further including instructions for configuring the database to be populated with previously performed component design reports for each respective component of the machine.

15. The computer-readable medium of claim 13 wherein the user-interface device includes a data field configurable for conducting a report search based on one or more search parameters, with at least one of said search parameters selected from the group consisting of report initiator, site coordinator, component name, drawing number, report number, machine type, present status of report, supplier of the component, any user identified as a point of contact for any given report, and site responsible for the component design.

16. The computer-readable medium of claim 13 wherein the user-interface device includes a clickable icon for electronically copying files from an existing report including component drawings and documentation usable for a new component design report.

17. The computer-readable medium of claim 13 wherein the user-interface device includes a clickable icon for accessing a working list including each component design report and associated tasks that require action from a respective user.

18. The computer-readable medium of claim 13 wherein the user-interface device includes a clickable icon for accessing a list indicative of the status of each respective component design report and tasks associated therewith.
